(19) United States
(12) Patent Application Publication
(10) Pub. No.: US 2026/0209515 A1
(43) Pub. Date: Jul. 23, 2026

(54) POLYAMIDE COMPOSITION, PROCESS FOR PREPARATION, PROCESS FOR PRODUCING AN ARTICLE, AND ARTICLE MADE OF THE COMPOSITION

(71) Applicant: ENVALIOR B.V., Geleen (NL)

(72) Inventors: Beert Jacobus KEESTRA, Waalre (NL); Wilhelmus Josephus Maria SOUR, Geleen (NL); Ruth Dorina LOSEN, Herzogenrath (DE)

(21) Appl. No.: 19/158,158

(22) PCT Filed: Feb. 16, 2024
(86) PCT No.: PCT/EP2024/054038

§ 371 Date: Aug. 20, 2025

(30) Foreign Application Priority Data
Feb. 27, 2023 (EP) 23158841.9

(51) Int. Cl. C08L 77/02; B29C 41/04; B29K 77/00; B29K 105/16; B29K 509/00; C08K 3/014; C08K 3/34; C08K 5/00

(52) U.S. Cl. CPC C08L 77/02; C08K 3/014; C08K 3/34; C08K 5/005; B29C 41/04; B29K 2077/00; B29K 2105/16; B29K 2509/00; C08K 2003/343; C08K 2201/005; C08L 2201/08; C08L 2205/02; C08L 2205/03; C08L 2205/035

(57) ABSTRACT

The present invention concerns an impact modified polyamide composition comprising at most 77.5 parts by weight (pbw) of an aliphatic polyamide (APA) having a relative viscosity (RV), measured at 0.01 g/ml in 96% sulphuric acid and at 25° C. by the method according to ISO307:2019, of at most 2.40; and at least 22.5 pbw of a modified polyolefin impact modifier (MIM) having a melt flow rate (MFR), measured at 230° C. and a test load of 2.16 kg by the method according to ISO 1133:2011, of at most 15 g/10 min, wherein the sum of both amounts is 100 pbw. The invention also relates to a process for preparing the impact modified polyamide composition, to a process for producing a molded article from the impact modified polyamide composition, and to a molded article made of the impact modified polyamide composition.

The present invention relates to a polyamide composition, more particular to an impact modified polyamide composition comprising an aliphatic polyamide (APA) and a modified polyolefin impact modifier (MIM). The present invention also relates to a process for preparing the impact modified polyamide composition, to a process for producing a molded article from the impact modified polyamide composition, and to a molded article made of the impact modified polyamide composition.

The invention is directed in particular to an impact modified polyamide composition which can be used in rotational molding applications, for example, gas containers and fuel tanks; the technology used for the production thereof also referred to as roto-molding or rotational molding. For rotational molding, good flow properties are needed to produce high quality products with low porosity, evenness in wall thickness and a smooth surface, while for application in pressurized gas containers and fuel tanks, good mechanical properties and a high impact resistance at low temperature are further required.

Impact modified polyamide compositions are known in the art. Impact modified polyamide compositions and rotational molded articles made thereof are described in, for example, US2021/0139699A1. In US2021/0139699A1, two other patent documents are referred to: WO2017/094720 (=US2021/0301131A1) and JP2013-532748 (=U.S. Pat. No. 9,309,406B2). Both documents describe impact modified polyamide compositions, with US2021/0301131A1 being primarily directed to injection molded parts, whereas U.S. Pat. No. 9,309,406B2 is directed to fuel parts which can be made by injection-molding, or blow molding, or roto-molding.

According to US2021/0301131A1 there has been a demand for a polyamide resin composition having excellent moldability (measured by spiral flowability during injection molding) or appearance (surface gloss) as a molded product, which does not impair the intrinsic mechanical strength (impact resistance) exhibited by a polyamide resin as much as possible and is provided with flexibility. US2021/0301131A1 mentions that there can be a problem with the flowability of polyamide compositions; and although the flowability can be improved by using a polyamide resin having a low molecular weight or using a fluidity modifier (plasticizers or waxes), these methods in return have different problems, such as reduction of impact strength, and thus have limitations in applications thereof. US2021/0301131A1 claims to have solved these problems by using a specific acid-modified modified polyolefin (Q) with a melt flow rate (MFR) at 230° C. under a load of 2.16 kg of 50 to 200 g/10 min in an amount of 1 to 50 wt. %, in combination with 50 to 99 wt. % of a polyamide. According to US2021/0301131A1, by controlling the MFR of the acid-modified polyolefin (Q) within this range, a polyamide resin molded product having an excellent balance between impact resistance and specular glossiness or an excellent balance between impact resistance and fluidity during molding of a molded product is obtained. In the examples of US20210301131A1, a polyamide 66 with a viscosity number 145-150 cm³/g, was used for the polyamide (P) and two grades of modified polyolefins Q were tested individually and used in amounts of 10 wt. % or 20 wt. %. However, with 10 wt. %, the values for the elongation at break (23° C.) were very low, whereas with the 20 wt. % the melt viscosities were very high, even at a temperature as high as 290° C., making these materials unsuitable for use in rotational molding. Furthermore, US2021/0139699 also discloses that although in US20210301131A1 the liquidity is improved by using a polyolefin having a relatively lower viscosity as the acid modified polyolefin, the impact resistance particularly at low temperature is decreased.

U.S. Pat. No. 9,309,406B2 (corresponding with JP2013-532748) relates to a fuel part, comprising a polymer composition comprising: a polyamide which has a ratio of terminal carboxy group concentration over terminal amino group concentration of 1 or more, a micro talcum in an amount of 0.001 to 1 wt. % based on the total amount of the polymer composition, and an impact modifier in an amount of at least 1.0 wt. %, based on the total amount of the polymer composition. In the examples, the following components were used: polyamide PA6; micro-talcum (with a median diameter of 0.50 micrometer, 99% was less than 5 micrometer, 92% less than 2 micrometer and 75% less than 1 micrometer); and a maleic anhydride (MAH) grafted ethene copolymer as impact modifier. Examples with 9.75 wt. % and 20 wt. % of impact modifier were reported. The patent document JP2013-532748 was commented in US2021/0139699A1, by disclosing that the blend of the impact resistance improving agent and the polyamide resin results in significantly increase of the viscosity of the polyamide resin composition obtained by the chemical reaction between them; and that the rotational molded article obtained by rotational molding of such a polyamide resin composition has poor surface property such that a particulate tends to remain at the surface, which was not suitable for the application for rotational molding.

US2021/0139699A1 describes an impact modified polyamide resin composition for rotational molding and a rotational molded article using the same. The polyamide resin composition of US2021/0139699A1 comprises:
component (A): an aliphatic polyamide having a relative viscosity (ηr) of less than 2.6 (as measured according to JIS K6920 under the conditions of 96 wt. % of sulfuric acid, 1 wt. % of the polymer concentration and 25° C.) in an amount of ‘a’ parts by weight (pbw);
component (B): a modified polyolefin having a density of 0.895 g/cm² or less as measured according to ASTM D1505 in an amount of ‘b’ pbw; and
component (C): a non-modified polyolefin having an MFR value of 3.0 to 30 g/10 min as measured in a load of 2.16 kg at 190° C. in an amount of ‘c’ pbw;
wherein the polyamide resin composition satisfies the following equations:

50≤c/(b+c)×100=70, and 10≤(b+c)/(a+b+c)×100≤40.

In other words, the amount of the modified polyolefin (B) is at most half of the combined amount of the modified polyolefin (B) and the non-modified polyolefin (C), and (B) also is at most 20 pbw, relative to the total amount of the polyamide (A) and components (B) and (C).

In the examples of US2021/0139699A1, a polyamide 6 with a relative viscosity (ηr) of 2.20, or with a relative viscosity (ηr) of 2.45 was used for component (A), a maleic anhydride-modified ethylene-α-olefin copolymer (TAFMER MH5020, density=0.866) for component (B) (amount 6.8 to 13.0 pbw), and a non-modified polyolefin (EVOLUE SP0540, MFR value=3.8 g/10 min at 190° C., 2.16 kg; ISO 1133)) for component (C) (amount 13.2-17.2 pbw). In most compositions a semi-aromatic polyamide (8.0 pbw or 15 pbw) was present. The amount of polyamide 6 (component A) was making up for the total of 100 pbw. Among the properties reported are surface quality, Charpy impact strength values at −60° C. and tensile elongation at 23° C., which show the presence of the non-modified polyolefin to being essential for the results. However, although the surface quality is better for the compositions with the polyamide 6 with a relative viscosity (ηr) of 2.20, the mechanical properties of impact strength and tensile elongation are better for the composition with the polyamide 6 having a relative viscosity (ηr) of 2.45 in combination with 15 pbw of semi-aromatic polyamide. Furthermore, comparative experiments show that mechanical properties improve with a higher content in non-modified polyolefin, but surface properties are not satisfactory, while the mechanical properties decrease with a lower content in non-modified polyolefin or the absence of the semi-aromatic polyamide.

US2021261773A1 relates to a composition comprising: a) 30-90 wt % of a polyamide and b) 10-40 wt % of a polyethylene elastomer (POE) composition, wherein the amounts of a) and b) are with respect to the total composition, wherein the total of a) and b) is at least 60 wt % with respect to the total composition, wherein the POE composition consists of: b1) 20-95 wt % of a non-functionalized polyethylene elastomer and b2) 5-80 wt % of a functionalized polyethylene elastomer, wherein the amounts of b1) and b2) are with respect to the POE composition. US2021261773A1 mentions that the composition may be used for rotational moulding.

JP 2004 346240 A concerns a polyamide resin composition which can give a molded article excellent in rigidity, heat-enduring rigidity, dimensional stability, impact resistance, toughness, flow property and appearance. The composition is described to be suitable as structural or exterior members of electrical/electronic and automobile parts. The thermoplastic polyamide resin composition contains (A) a thermoplastic polyamide resin component, (B) an olefin-based polymer component grafted/modified with an unsaturated dicarboxylic acid, (C) talc component, and (D) a pentaerythritol type phosphite component in specific ratios.

Apart from the criticality of the flowability of the materials to obtain products with low porosity, evenness in wall thickness and smooth surface, good mechanical properties in tensile tests and a high impact resistance in Charpy impact tests, both at room temperature and at low temperature, the inventors have observed that impact modified polyamide compositions generally exhibit poor or even bad results in impact tests with a falling weight. Falling weight impact test result is an indication for the mechanical performance of the tank produced. A poor falling weight impact result indicates that the tank will not pass the mechanical requirements, usually a drop test at −40° C. from a certain height. This property can be relevant during transport of rotomolded products or in the practical use.

Accordingly, an object of the present invention is to provide a polyamide composition that is preferably suitable for rotational molding and has a good balance in flowability, mechanical properties and impact resistance at room temperature and at low temperature and exhibit good results in a falling weight impact test. A further object is to provide a rotational molded article having a good balance in surface quality, mechanical properties and impact resistance at room temperature and at low temperature and exhibiting satisfactory results in a falling weight impact test.

These objects have been achieved with the polyamide composition according to the invention, and with the rotational molded article using the same polyamide composition.

The polyamide composition according to the invention is an impact modified polyamide composition consisting of:
X parts by weight (pbw) of an aliphatic polyamide (APA), and
Y parts by weight (pbw) of a modified polyolefin impact modifier (MIM), and
one or more other polymer components and/or one or more additives (together herein referred to as other components Z), which differ from X and differ from Y, and which combinedly add up to an amount of 0-30 pbw, as defined relative to 100 pbw of the sum of X and Y);
   wherein
the aliphatic polyamide (APA) has a relative viscosity (RV), measured at 0.01 g/ml in 96% sulphuric acid and at 25° C. by the method according to ISO307:2019, of at most 2.40;
the modified polyolefin impact modifier (MIM) has a melt flow rate (MFR) measured at 230° C. and with a test load of 2.16 kg by the method according to ISO 1133:2011, of at most 15 g/10 min; and
the sum of X and Y is 100 pbw, and wherein X is at most 77.5 pbw and Y is at least 22.5 pbw, whereby
   for the relative viscosity (RV) of the aliphatic polyamide (APA) up to and including 2.20, X is at least 60 pbw and Y is at most 40 pbw;
   for the relative viscosity (RV) of the aliphatic polyamide (APA) in a range of between above 2.20 up to and including 2.33, X is at least 65 pbw and Y is at most 35 pbw; and
   for the relative viscosity (RV) of the aliphatic polyamide (APA) in a range of between above 2.33 up to and including 2.40, X is at least 70 pbw and Y is at most 30 pbw; and,
      wherein the other components Z comprise no more than 10 pbw of a non-modified polyolefin and no more than 2 pbw of a micro talcum, relative to the 100 pbw of the combined amount of X and Y, with the provision that, the one or more other polymer components and the one or more additives (together referred to as other components Z) differ from X and differ from Y, and combinedly add up to an amount in the range of 0-30 pbw relative to 100 pbw of the sum of X and Y.

The effect of the impact modified polyamide composition according to the invention comprising the polyamide and the modified polyolefin impact modifier with the said parameters in the said amounts is not only that the polyamide composition has a good balance in flowability, mechanical properties and impact resistance at room temperature and at low temperature, but also a positive falling weight impact test result at low temperature. A further effect is that the polyamide composition is suitable for rotational molding and that a rotational molded article made thereof not only has a good balance in surface quality, mechanical properties and impact resistance at room temperature and at low temperature, but also shows a tough performance in a falling weight impact test at low temperature.

As to the restriction of the polyamide composition comprising a restricted amount of others Z it is noted that inventors found that presence of an excess of other constituents can negatively affect one or more of: flowability, mechanical properties, impact resistance at room temperature and at low temperature, falling weight impact properties at low temperature, and/or gas barrier properties of the polyamide composition. Inventors in particular find that one or more of flowability and barrier properties may be progressively negatively affected by excessive addition of non-modified polyolefin (including non-modified impact modifiers), respectively excessive addition inorganic filler particles, specifically micro talcum.

These results are very surprising in several aspects, i.e., not only in that a good flowability is obtained with a modified polyolefin impact modifier having a low melt flow rate, even when using said modified polyolefin impact modifier in a relatively large amount, but also that good mechanical properties and impact resistance are obtained with a polyamide having in particular a low relative viscosity (RV), even in the absence, or the presence of a low amount, of a non-modified polyolefin, or a semi-aromatic polyamide, and at the same time also showing positive results in a falling weight impact test.

The aliphatic polyamide in the composition according to the invention is a polyamide obtainable by polymerizing a lactam, or an aminocarboxylic acid, or an aliphatic diamine and an aliphatic dicarboxylic acid, as raw materials, or copolymerizing any combination thereof, via known methods such as melt polymerization, solution polymerization, or solid phase polymerization. The aliphatic polyamide can be either
an AB type polyamide, obtainable by polymerizing a lactam and/or an aminocarboxylic acid; or
an AABB type polyamide, obtainable by copolymerizing an aliphatic diamine and an aliphatic dicarboxylic acid; or
an AB/AABB type polyamide, being a polyamide copolymer obtainable by copolymerizing a lactam and/or an aminocarboxylic acid in combination with an aliphatic diamine and an aliphatic dicarboxylic acid.

Examples of lactam include caprolactam, enantolactam, undecanelactam, dodecanelactam, α-pyrrolidone, and α-piperidone. Examples of the aminocarboxylic acid include 6-aminocaproic acid, 7-aminoheptanoic acid, 9-aminononanoic acid, 11-aminoundecanoic acid, and 12-aminododecanoic acid. In the AB type polyamide or AB/AABB copolymer, one kind of lactam or two or more kinds of lactam may be used.

In the AA/BB type polyamide or AB/AABB copolymer, one kind of aliphatic diamine or two or more kinds of them may be used. The aliphatic diamine suitably is a C2-C20 diamine, i.e., a diamine comprising 2 to 20 carbon atoms, preferably a C4-C12 diamine. The aliphatic diamine can be a linear aliphatic diamine, a branched aliphatic diamine, or a cyclic diamine, or any combination thereof. Examples of linear aliphatic diamine with 2 to 20 carbon atoms are 1,2 ethanediamine, 1,3-propanediamine, 1,4-butanediamine, 1,5-pentanediamine, 1,6-hexanediamine, 1,7-heptanedi amine, 1,8-octanediamine, 1,9-nonanediamine, 1,10-decanediamine, 1,11-undecanediamine, 1,12-dodecanediamine, 1,13-tridecanediamine, 1,14-tetradecanediamine, 1,15-pentadecanediamine, 1,16-hexadecanediamine, 1,17 heptadecanediamine, 1,18-octadecanediamine, 1,19-nonadecanediamine, 1,20-eicosanediamine. The branched aliphatic diamine suitably is a diamine with a methyl substituted aliphatic chain. Examples of branched aliphatic diamine with 4 to 12 carbon atoms are 2-methyl-1,5-pentanediamine, 3-methyl-1,5-pentanediamine, 2-methyl-1,8-octanediamine, 2,2,4-trimethyl-1,6-hexanediamine, 2,4,4 trimethyl-1,6-hexanediamine, and 5-methyl-1,9-nonanediamine.

Examples of the aliphatic dicarboxylic acid include oxalic acid, malonic acid, succinic acid, glutaric acid, adipic acid, pimelic acid, suberic acid, azelaic acid, sebacic acid, undecane diacid, dodecane diacid, tridecane diacid, tetradecane diacid, pentadecane diacid, hexadecane diacid, octadecane diacid, and eicosane diacid. In the AA/BB type polyamide or AB/AABB copolymer, one kind of aliphatic dicarboxylic acid or two or more kinds of them may be used.

Examples of AB-type polyamides are the homopolymers polycaprolactam (polyamide 6), polyundecaneamide (polyamide 11), polydodecaneamide (polyamide 12); and any copolymers thereof. Examples of AA/BB type polyamide are polytetramethylene sebacamide (polyamide 410), polyhexamethylene adipamide (polyamide 66), polyhexamethylene suberamide (polyamide 68), polyhexamethylene azelamide (polyamide 69), polyhexamethylene sebacamide (polyamide 610), polyhexamethylene dodecamide (polyamide 612). Examples of copolymer of the AB/AABB type polyamide are polyamide 6/66, polyamide 6/410, polyamide 6/68, polyamide 6/610, and polyamide 6/6/12.

The aliphatic polyamide (APA) may comprise monomeric components others than those based on lactam, aminocarboxylic acid, aliphatic diamine, and aliphatic dicarboxylic acid; and referred to herein as other or additional monomeric components. Examples of other monomeric components include monoamine, triamine, and polyamine, monocarboxylic acid, dicarboxylic acid, and tricarboxylic acid. These other monomeric components may be either aliphatic monomeric components or aromatic monomeric components. The other monomeric components may also comprise other aromatic monomeric components such as aromatic diamine and aromatic dicarboxylic acid. The aliphatic polyamide in the composition according to the invention suitably comprises other monomeric components in an amount of at most 10 mole %. Herein the aliphatic polyamide may comprise up to and including 5 mole % of an aromatic monomeric component, while still being considered an aliphatic polyamide. For example, the aliphatic polyamide may comprise 3 mole % of an aromatic monomeric component, in combination with at most 7 mole % of other aliphatic monomeric components, or 5 mole % of an aromatic monomeric component, in combination with at most 5 mole % of other aliphatic monomeric components. Preferably, the aliphatic polyamide comprises 0-5 mole %, more preferably 0-2 mole % of another monomeric component. Herein the other monomeric component can be one other monomeric component, or two or more other monomeric components. Herein the mole percentage (mole %) is relative to the total molar amount of lactam or carboxylic acid, aliphatic diamine, aliphatic dicarboxylic acid, and other monomeric components copolymerized in the aliphatic polymer. Examples of other monomeric components that can be copolymerized into the aliphatic polyamide are known in the art.

Among the aliphatic polyamides, that may be used in the composition according to the present invention, the following are preferred: polyamide 6, polyamide 11, and polyamide 12; and polyamide-6 copolymer obtainable by copolymerization of caprolactam or 6-aminocaproic acid, or a combination thereof, with aliphatic comonomers selected from
another lactam and/or aminocarboxylic acid, or
an aliphatic diamine and an aliphatic dicarboxylic acid, or
another lactam and/or aminocarboxylic acid, and an aliphatic diamine and an aliphatic dicarboxylic acid.
   These polyamides are preferred for their heat stability during molding and for the molding processability. More preferably, the polyamide is a polyamide 6 polymer, being a polyamide 6 homopolymer; or a polyamide 6 copolymer comprising at most 25 mole % of aliphatic comonomer. Even more preferred, the polyamide-6 polymer comprises 0-10 mole %, and even more preferred 0-5 mole %, and most preferred 0-2 mole % of aliphatic comonomer. Herein the mole percentage (mole %) is relative to the total amount of caprolactam or 6-aminocaproic acid and aliphatic comonomer copolymerized in the aliphatic polymer.

The aliphatic polyamide in the composition according to the present invention suitably is a semi-crystalline polyamide. The semi-crystalline polyamide may have a melting temperature (Tₘ) varying over a wide range. Suitably, the meting temperature Tₘ is as high as 280° C. or higher, or as low as 160° C., or lower. Herein Tₘ is measured by the method according to ISO 11357-3:2018, with a heating ramp of 10° C./min. Preferably, Tₘ is in the range of 180-260° C., more preferably in the range of 190-240° C. The advantage thereof is that the composition has a more balanced combination of properties in terms of molding processability, heat stability during molding and mechanical properties for the molded parts.

Herein, a range is understood to also include the lower and the upper limit. Thus, for instance, in the expression ‘in the range of 180-260° C.’, the range includes the lower limit of 180° C., as well as the upper limit of 260° C.

The aliphatic polyamide may be a mixture of two or more polyamides. Herein the polyamides may have a different relative viscosity (RV). In this case, the relative viscosity (RV) of the aliphatic polyamide in the composition according to the invention is the relative viscosity measured for the mixture of the two or more polyamides, at a concentration of 0.01 g of the mixture of the two or more polyamides in 1 ml in 96% sulphuric acid and at 25° C. by the method according to ISO307:2019.

For the composition of the present invention, it is essential that the relative viscosity (RV) of the aliphatic polyamide is at most 2.40, not only to achieve good flowability, but also making it possible to use the modified polyolefin impact modifier (MIM) in a sufficiently high amount to obtain the effects of the present invention. For RV in excess of 2.40 inventors find the composition progressively less capable of simultaneously realizing appropriate qualities for rotamoulding in combination with an appropriate amount of MIM. Below the 2.40, the relative viscosity (RV) may vary over a wide range. Suitably, the relative viscosity (RV) is as low as 1.90, or even lower, for example 1.80. Preferably, the relative viscosity (RV) is at least 1.90, more preferably at least 2.00. For example, the RV can be in a range of 1.80-2.40, preferably 1.90-2.40, more preferably 2.00-2.40. This has the advantage that the mechanical properties are better retained at a high level including good Charpy impact resistance and acceptable falling weight impact resistance. Also preferably, the viscosity is at most 2.35, more preferably at most 2.30 and even more preferably at most 2.25. This has the advantage that the flowability is improved while mechanical properties are retained at a prominent level including good Charpy impact resistance and acceptable falling weight impact resistance.

The modified polyolefin impact modifier (MIM) in the composition according to the present invention has a melt flow rate (MFR) measured at 230° C. and with a test load of 2.16 kg by the method according to ISO 1133:2011, of at most 15 g/10 min. The MFR may vary over a broader range, and may be as low as, for example, 0.25 g/10 min. At too low MFR values, the flowability of the composition is hampered too much for practical use thereof, for example in rotational molding. At too high MFR values for the modified polyolefin impact modifier (MIM), the mechanical properties are not good, in particular with the polyamide having the relative viscosity (RV) according to the present invention.

Preferably, the MFR of the modified polyolefin impact modifier (MIM) is at least 0.5 g/10 min, more preferably at least 0.6 g/10 min, even more preferably at least 0.8 g/10 min. Also preferably, the MFR of the modified polyolefin impact modifier (MIM) is at most 10.0 g/10 min, more preferably at most 7.0 g/10 min, even more preferably at most 5.0 g/10 min. Most preferred, the MFR of the modified polyolefin impact modifier (MIM) is in the range of 0.5-10 g/10 min, or in the range of 0.8-5 g/10 min, or in the range of 1.0-3 g/10 min.

With a modified polyolefin impact modifier is herein understood a polymer comprising a polyolefin backbone modified with functional groups. The polyolefin backbone is suitably a copolymer of different olefinic monomers, in particular α-olefinic monomers with 2-20 carbon atoms. Example of such α-olefinic monomers include ethylene, propylene, 1-butene (butylene), isobutylene, 1-pentene, 1-hexene, 1-heptene, 1-octene, 1-decene, 1-dodecene, 1-hexadecene, 1-octadecene, and 4-methyl-1-pentene. The polyolefin backbone preferably is a copolymer of two olefins selected from ethylene, propylene, and butylene; or a copolymer of ethylene, propylene, and butylene; or a copolymer of at least one olefin selected from ethylene, propylene and butylene, and at least one other α-olefinic monomer with 4-20 carbon atoms. Herein, ethylene-α-olefin copolymers and propylene-α-olefin copolymers are preferred. Herein ethylene in the ethylene-α-olefin copolymers, respectively propylene in the propylene-α-olefin copolymers, is suitably present in an amount of at least 20 mole %, more preferably at least 40 mole %. Among these ethylene-α-olefin copolymers are more preferred, and ethylene-butylene copolymers and ethylene-1-octene copolymers, are even more preferred.

The polyolefin backbone may further comprise monomeric units derived from unsaturated monomers other than olefinic monomers. These other unsaturated monomer, or other unsaturated monomers can be, for example, a diene monomer or an aromatic monomer, or a combination thereof. Examples of the diene monomers (for instance, contained in the ethylene-α-olefin copolymer, or in the propylene-α-olefin copolymer) include unconjugated diene components such as 1,4-hexadiene, dicyclopentadiene, 5-ethylidene-2-norbornene, and 2,5-norbornadiene; and conjugated diene components such as butadiene, isoprene and piperylene. Examples of the aromatic monomers (for instance, that may be contained in the ethylene-α-olefin copolymer or the propylene-α-olefin copolymer) include styrene. The other unsaturated monomer can be present, if at all, in an amount of at most 20 mole %, preferably at most 10 mole %, and more preferred in an amount of 0-5 mole %. Herein the mole % is relative to the total molar amount of olefinic monomer and other unsaturated monomer in the polyolefin backbone. Polyolefins comprising other unsaturated monomer copolymerized in combination with olefinic monomer, and modified polyolefin impact modifier comprising a polyolefin backbone comprising other copolymerized unsaturated monomer are known in the art.

The modified polyolefin impact modifier comprises a polyolefin backbone modified with functional groups. Examples of suitable functional groups include acid groups, epoxy groups and glycidyl groups. The modified polyolefin impact modifier used in the present invention is preferably an acid-modified polyolefin, an epoxy modified polyolefins, or a glycidyl-modified polyolefin, or any combination thereof. Among these, acid-modified polyolefins are particularly preferred. The acid-modified polyolefin can be obtained by modifying a polyolefin with an unsaturated carboxylic acid or an acid anhydride thereof. Examples of the unsaturated carboxylic acid or the acid anhydride thereof include maleic acid, fumaric acid, itaconic acid, acrylic acid, meth acrylic acid, cis-4-cyclohexen-1,2-dicarboxylic acid, maleic anhydride, itaconic anhydride, and cis-4-cyclohexen-1,2 dicarboxylic acid anhydride. Among these, maleic anhydride or itaconic anhydride is preferred, and maleic anhydride is more preferred. As a substitute for the unsaturated carboxylic acid or anhydride thereof, a derivative such as an acid amide and an acid ester may be used.

The amount of the modifying functional groups in the modified polyolefin impact modifier may vary. The amount of the functional groups can be expressed as functional modification amount, expressed in weight percentage (wt. %), relative to the weight of the modified polyolefin impact modifier (MIM).

Suitably, the modified polyolefin impact modifier (MIM) has a functional modification amount of at least 0.25 wt. %. Also suitably, the modified polyolefin impact modifier (MIM) has a functional modification amount of at most 2.5 wt. %, preferably at most 2.0 wt. %. More preferably, the functional modification amount is in the range of 0.3-1.5 wt. %; even more preferably in the range of 0.4-1.0 wt. %. Herein the weight percentages (wt. %) are relative to the total weight of the modified polyolefin impact modifier. With acid-modified polyolefins being particularly preferred, the modified polyolefin impact modifier (MIM) preferably has an acid modification amount of at least 0.25 wt. % and at most 2.0 wt. %, more preferably in the range of 0.3-1.5 wt. %, and most preferred in the range of 0.4-1.0 wt. %. A specially preferred acid-modified polyolefin is a polyolefin modified with maleic anhydride. The corresponding maleic anhydride-modified polyolefin suitably comprises at least 0.25 wt. %, or at most 2.5 wt. %, preferably 0.3-1.5 wt. %, more preferable 0.4-1.0 wt. % of maleic anhydride, relative to the weight of the modified polyolefin impact modifier.

Suitably, the modified polyolefin impact modifier (MIM) has a glass transition temperature (T_{g}) of below 0° C., and may be as low as −70° C., and even lower. Preferably, the modified polyolefin impact modifier (MIM) has a T_{g} of at most −40° C., more particular in the range of −40° C.-−70° C., more preferably at most −50° C., more preferably at most −55° C., and most preferably at most −60° C. Herein T_{g} is measured by the method according to ISO 11357-2:2020, with a heating ramp of 10° C./min.

The modified polyolefin impact modifier (MIM) preferably has a glass transition temperature (T_{g}) of −50° C. or below, and may be as low as −70° C., and even lower. More preferably, the modified polyolefin impact modifier (MIM) has a T_{g} of at most −55° C., even more preferably at most −60° C. Herein T_{g} is measured by the method according to ISO 11357-2:2020, with a heating ramp of 10° C./min. A low T_{g} is preferred from the viewpoint of mechanical properties at low temperature.

Preferably, the modified polyolefin impact modifier (MIM) has a density of below 1 g/cm³. The density may be as low as 0.80 g/cm³, or even lower, but suitably is 0.80 g/cm³ or above, for example at least 0.84 g/cm³. More preferably, the modified polyolefin impact modifier (MIM) has a density of at most 0.95 g/cm³, even more preferably at most 0.90 g/cm³, more particularly in the range of 0.80-0.90 g/cm³, and most preferably at most 0.88 g/cm³. The density more particularly is in the range of 0.84-0.88 g/cm³. Herein the density is measured by the method according to ASTM D1505-03. A low density is preferred from the viewpoint of mechanical properties at low temperature.

Preferably, the modified polyolefin impact modifier (MIM) has a Shore A hardness of below 100. The Shore A hardness may be as low as 40, or even lower, but suitably is above 45 or above, for example at least 50. More preferably, the modified polyolefin impact modifier (MIM) has a Shore A hardness of at most 90, even more preferably of at most 80, more particularly in the range of 45-80, and most preferably of at most 75. The Shore A hardness more particularly is in the range of 50-75. Herein the Shore A hardness is measured by the method according to ASTM D2240-15. A low Shore A hardness is preferred from the viewpoint of mechanical properties at low temperature.

The modified polyolefin impact modifier (MIM) can be present in the composition according to the invention in an amount of at least 22.5 pbw, and in a range depending on the relative viscosity of the aliphatic polyamide.

For the relative viscosity (RV) of the aliphatic polyamide (APA) up to and including 2.20, X is at least 60 pbw and Y is at most 40 pbw. For the relative viscosity (RV) of the aliphatic polyamide (APA) in said range, preferably X is in the range of 62.5-75 pbw and Y is in the range of 25-37.5 pbw.

For the relative viscosity (RV) of the aliphatic polyamide (APA) in a range of higher than 2.20 and at most 2.33, X is at least 65 pbw and Y is at most 35 pbw.

Preferably, for the relative viscosity (RV) of the aliphatic polyamide (APA) in a range of higher than 2.20 and at most 2.27, X is in the range of 65-75 pbw and Y is in the range of 25-35 pbw; whereas for the relative viscosity (RV) of the aliphatic polyamide (APA) in a range of higher than 2.27 and at most 2.33, preferably X is at least 69 and Y is at most 31 pbw.

For the relative viscosity (RV) of the aliphatic polyamide (APA) in a range of higher than 2.33 and at most 2.40, X is at least 70 pbw and Y is at most 30 pbw. Preferably, for the relative viscosity (RV) of the aliphatic polyamide (APA) in said range, X is at least 72.5 pbw and Y is at most 27.5 pbw.

The advantage of the amount of the modified polyolefin impact modifier (MIM) in the above preferred ranges in combination with the said ranges for the relative viscosity (RV) of the aliphatic polyamide (APA), is that the composition has an improved balance in properties, in particular in terms of flowability and mechanical properties.

Preferably, the impact modified polyamide composition has a combination of properties complying with all of the following parameters:
a complex viscosity (Eta*) at 250° C. of at most 700 Pa·s;
an elongation at break at −40° C. of at least 17.5%;
a notched impact strength at 23° C. of at least 70 KJ/m²; and
a falling weight impact resistance at −40° C. with a success rate of at least 60%.

Herein the various properties are measured by the following methods:
the complex viscosity (Eta*) is measured with dynamic mechanical spectroscopy (DMS) by the method according to ISO 6721-10, with loading time of 5 min, at an angular frequency of 0.1 rad/s.
the elongation at break is measured by the method according to ISO 527-2:2012 Type 1A at a drawing rate of 50 mm/min;
the notched impact strength is measured by the method according to ISO 179-2:2020; and
the falling weight impact resistance is measured on 5 injection molded plaques of 80*80*2 mm by the method according to ISO 6603-2-2000-10, and the success rate is determined as the percentage of the plaques that passed the test.

The value for the complex viscosity (Eta*) of the composition can be, for example, about 550 Pa·s, about 425 Pa·s, about 300 Pa·s, or about 250 Pa·s.

Suitably, the complex viscosity (Eta*) is at least 200 Pa·s.

More preferably, the impact modified polyamide composition has a complex viscosity (Eta*) at 250° C. of at most 600 Pa·s; more preferably at most 500 Pa·s. The advantage of a lower complex viscosity is that processing of the composition runs smoother and, in the processing, a less high a molding temperature is needed to obtain high quality products.

Also more preferably, the impact modified polyamide composition has a combination of properties complying with one or more of the following parameters:
an elongation at break at −40° C. of at least 20%; and/or
a notched impact strength at 23° C. of at least 75 KJ/m², most preferably at least 80 KJ/m².

The value for the complex elongation-at-break at −40° C. of the composition can be, for example, about 20%, about 25%, about 36%, about 43% or about 48%. Suitably, the elongation-at-break at −40° C. is at most 60%, or even at most 50%, while still obtaining good to very good results.

The notched impact strength at 23° C. can be, for example, about 83 KJ/m², or about 88 KJ/m², or about 97 KJ/m², Whereas the notched impact strength may be higher than, for example, 110 KJ/m², it suitably is at most 110 KJ/m², more particular at most 105 KJ/m².

More preferably, the impact modified polyamide composition has a falling weight impact resistance at −40° C. with a success rate of at least 80%. The success rate can be as high as 100%, with all tested plaques passing the test successfully.

The impact modified polyamide composition according to the invention, may also comprise, in addition to the aliphatic polyamide and the MIM, one or more other polymer components and/or one or more additives, which constitute part of other components. These other components can be present, as desired, in an amount within a range not impairing the purpose of the present invention. The additive(s) and/or the other polymer component(s), may suitably be present in an amount in the range of 0.001-30 pbw, preferably in the range 0.01-20 pbw and more preferable in the range 0.1-10 pbw. Herein the parts by weight (pbw) are relative to the 100 pbw for the combined amount X and Y, wherein X represents the amount of the aliphatic polyamide in pbw, and wherein Y represents the amount of the modified polyolefin impact modifier (MIM) in pbw. Inventors found that addition of other components (others Z) in an amount in excess 30 pbw (relative to the sum of X and Y) can negatively affect one or more of the properties of the composition.

The other polymer component can be any polymer component or a mixture of polymer components typically used in non-reinforced impact modified polyamide compositions, as long as it does not impair the purpose of the present invention. Suitable examples of other polymer components are semi-aromatic polyamides, other thermoplastic polymers, non-modified polyolefins, and rubbers.

The non-modified polyolefin in the other polymer component can be, for example, a polyolefin homopolymer or a polyolefin copolymer. Examples of polyolefin homopolymers are polyethylene and polypropylene. Examples of polyolefin copolymers are the unmodified polyolefin copolymers used for the backbones in the MIM. Preferably, the non-modified polyolefin is selected from polyethylene, polypropylene, ethylene-α-olefin copolymer, and propylene-α-olefin copolymer., The non-modified polyolefin can be present in an amount of at most 10 pbw, more preferable at most 7.5 pbw, and at least 1 pbw. Even more preferably, the amount of non-modified polyolefin is in the range of 0-5 pbw, relative to the 100 pbw for the combined amount X and Y.

The semi-aromatic polyamide in the other polymer component can be a copolymer of an aromatic dicarboxylic acid and an aliphatic diamine; or a copolymer of an aliphatic dicarboxylic acid, an aromatic dicarboxylic acid, and an aliphatic diamine; or a copolymer of an aliphatic dicarboxylic acid, an aromatic diamine and an aliphatic diamine; or a copolymer of an aliphatic dicarboxylic acid and an aromatic diamine; or a copolymer of an aliphatic dicarboxylic acid, an aromatic dicarboxylic acid, an aromatic diamine, and an aliphatic diamine. The semi-aromatic polyamide can be a semi-crystalline semi-aromatic polyamide or an amorphous semi-aromatic polyamide. Preferably, the semi-crystalline semi-aromatic polyamide has a melting temperature (Tₘ), measured by the method mentioned herein, of at most 260° C., more preferably at most 240° C., and suitably at least 190° C. Even more preferably, the semi-aromatic polyamide is an amorphous semi-aromatic polyamide.

The semi-aromatic polyamide in the other polymer component may comprise aliphatic diamine units having 6-12 carbon atoms, derived from a diamine, or a combination of diamines, selected from the group consisting of 1,6-hexanediamine, 1,7-heptanediamine, 1,8-octanediamine, 1,9-nonanediamine, 1,10-decanediamine, 1,11-undecanediamine, and 1, 12-dodecanediamine. Next to the aliphatic diamine, the semi-aromatic polyamide may comprise aromatic dicarboxylic acid units derived from dicarboxylic acids selected from the group consisting of terephthalic acid, isophthalic acid and naphthalenedicarboxylic acid.

The semi-aromatic polyamide can be, in particular, a 6T copolymer, i.e., a copolymer comprising 6T units next to units from other monomers. Specific examples of the semi-aromatic polyamide suitable for use in the composition according to the invention include poly(hexamethylene terephthalamide/hexamethylene isophthalamide) copolymer (polyamide 6T/61), poly(hexamethylene terephthalamide/hexamethylene adipamide) copolymer (polyamide 6T/66), poly(hexamethylene terephthalamide/hexamethylene sebacamide) copolymer (polyamide 6T/610), poly(hexamethylene terephthalamide/hexamethylene dodecamide) copolymer (polyamide 6T/612), poly(hexamethylene terephthalamide/hexamethylene isophthalamide/hexamethylene adipamide) copolymer (polyamide 6T/61/66), poly(hexamethylene terephthalamide/2-methyl pentamethylene terephthalamide) copolymer (polyamide 6T/M5T), poly(hexamethylene terephthalamide/caproamide) copolymer (polyamide 6T/6). More preferred examples include poly(hexamethylene isophthalamide/hexamethylene terephthalamide) copolymer (polyamide 61/6T), poly(hexamethylene isophthalamide/hexamethylene terephthalamide/hexamethylene adipamide) copolymer (polyamide 61/6T/66), and mixtures thereof.

Preferably, the semi-aromatic polyamide in the other polymer component is present in an amount of at most 10 pbw, more preferably at most 7.5 pbw, even more preferably at most 5.0 pbw. Most preferably, the amount of semi-aromatic polyamide is in the range of 0-2.5 pbw, relative to the 100 pbw for the combined amount X and Y.

The additive that may be further present in the impact modified polyamide composition according to the invention can be any additive, or a mixtures of additives, selected from auxiliary additives typically used in non-reinforced impact modified polyamide compositions. Without limiting to the following, the additive can be selected from the group of stabilizers (including heat stabilizers, UV absorbers, light stabilizers, and antioxidants), anti-static agents, lubricants, anti-blocking agents, fillers, crystal nucleating agents, mold release agents, plasticizers, crosslinking agents, foaming agents, colorants (pigments, dyes).

Preferably, the additive is in an amount of at most 10 pbw, more preferably at most 7.5 pbw. Although the amount may be 0 pbw, even more preferably, the amount of additive is in the range of 0.1-5 pbw, relative to the 100 pbw for the combined amount of X of and Y.

Inventors find that, a higher relative content of other constituents (Z) can negatively affect one or more of flow behavior, and mechanical properties of a rotomolded part, e.g. impact resistance, especially at low temperatures.

Preferably, the impact modified polyamide composition comprises at least one stabilizer. The advantage thereof is that in case of presence of oxygen during processing, the quality of the molded product is better retained. The stabilizer can be an organic stabilizer, or an inorganic stabilizer, or a combination thereof.

Examples of organic stabilizers include antioxidants, such as phenol-based antioxidants, thioether-based antioxidants, and/or phosphorus-based antioxidants. The organic stabilizer is preferably at least one selected from the group consisting of phenol-based antioxidants and phosphorus-based antioxidants, and more preferably is at least one selected from the group consisting of hindered phenol-based antioxidants having a t-butyl group at the ortho position, and phosphite ester-based antioxidants of a phenol having a t-butyl group at the ortho position. Suitably, the organic stabilizer is present in an amount in the range of 0.1-2 pbw, more particular 0.3-1.5 pbw and preferably 0.5-1.2 pbw, relative to the 100 pbw for the combined amount of X and Y.

Examples of inorganic stabilizers include metal halides, for example a copper halide. A particular example of such an inorganic stabilizer is a mixture of cuprous iodide with potassium bromide (CuI/KBr).

Preferably, the impact modified polyamide composition comprises at least an inorganic stabilizer, that is more preferably a copper halide. Even more preferably, the composition comprises the copper halide stabilizer in an amount of at least 50 ppm, preferably at least 100 ppm of Cu, relative to the total weight of the impact modified polyamide composition.

More preferably, the impact modified polyamide composition comprises an organic stabilizer in an amount of at least 0.5 pbw and a copper based inorganic stabilizer in an amount of at least 50 ppm, preferably of at least 100 ppm of Cu. Herein, the parts by weight (pbw) are relative to 100 pbw for the combined amount of aliphatic polyamide (X) and modified polyolefin impact modifier MIM (Y). Herein, the parts per million (ppm) are relative to the total weight of the impact modified polyamide composition.

Most preferably, a combination of a hindered phenol-based antioxidant having a t-butyl group at the ortho position and a copper based inorganic stabilizer, more particular a combination of a hindered phenol-based antioxidant having a t-butyl group at the ortho position and CuI/KBr is used.

The additive in the impact modified polyamide composition may comprise a filler. An example thereof is talcum, which is a hydrated magnesium silicate, or micro-talcum. Preferably, the composition comprises a micro-talcum. The micro-talcum may be any known micro-talcum suitable for use in polyamide compositions. The micro talcum preferably has a median diameter (d50) of less than 1 micrometer, more preferably less than 70 micrometer, even more preferred less than 50 micrometer. The particle size distribution of micro-talcum is determined by a high-speed image analyzer. This analyzer projects all particles in a limited sample into 2-dimensional images and measures the actual surface area of all captured separate particles. These surface areas are subsequently recalculated into circles having the same surface area of which the diameter is calculated. The median value (d50) of the particle size distribution is then determined by known means.

The micro-talcum may be present in the polymer composition in an amount up to 10 pbw, e.g. in an amount of 0.001 pbw to 10 pbw. Preferably, the micro-talcum may be present in the impact modified polyamide composition in an amount in a range of 0.01-5.0, more preferably in a range of 0.01-3.0 pbw, even more preferably in a range of 0.01-2.0 pbw, most preferably from 0.01 to 0.5 pbw. For example, in an embodiment the amount of micro talcum can preferably be 0.05 wt % with respect to a total mass of the composition. Inventors find amounts in a range of at least 0.01 up to about 3 pbw, preferably up to about 2 pbw, most preferably up to 1 pbw, progressively beneficial in providing good impact resistance at low temperature. Excessive amounts of talcum, for example in case of use as a bulk-filler, can result om high brittleness at low temperatures. Herein the amount of micro-talcum in parts by weight (pbw), is relative to the 100 pbw for the combined amount of X and Y.

The present invention also relates to process for preparing the impact modified polyamide composition according to the present invention. The impact modified polyamide composition is obtainable by melt-mixing the aliphatic polyamide (APA) and the modified polyolefin impact modifier (MIM) with the parameters in the amounts mentioned herein above. The impact modified polyamide composition can be prepared by, for example, melt-mixing the aliphatic polyamide, the MIM, and the optional further components to be added, as desired, by various methods known in the related art. Specifically, the impact modified polyamide composition can be obtained by charging the respective components simultaneously or sequentially into a mixing device such as a Henschel mixer, a V-type blender, a tumbler mixer, and a ribbon blender, heating and mixing them, and melt-kneading the mixture using, for example, a single-screw extruder, a multi-screw extruder, a kneader or a Banbury mixer. In particular, if a device having excellent kneading performance, such as a multi screw extruder, a kneader, and a Banbury mixer is used, a high-quality impact modified polyamide composition in which the respective components are more uniformly dispersed is obtained.

The present invention also relates to a process for producing a molded article from the impact modified polyamide composition, and to a molded article made of the impact modified polyamide composition.

The process according to the present invention is a rotational molding process using the impact modified polyamide composition according to the present invention, and any special or preferred embodiment thereof, as described herein above. Any rotational molding process known in the art can be used. The molding of the impact modified polyamide composition according to the present invention by rotational molding method can be performed, for example, by the following method. For instance, firstly, a metal mold can be attached to a known rotational molding apparatus which can turn, invert, or move in a pendulum motion at single axis or multiple axes, and impact modified polyamide composition, for example in the form of a powder, or pellets, is charged in the metal mold. Then, the inside the metal mold can be heated to a temperature of between a) Tₘ+5° C. and b) Tₘ+80° C. Herein, Tₘ is the melting temperature of the aliphatic polyamide. In other words, the metal mold can be heated to a temperature in the range of 5-80° C. above the melting temperature of the aliphatic polyamide. The impact modified polyamide composition is molded while melting the aliphatic polyamide at this temperature. After that, the metal mold is cooled to a temperature between c) the glass transition temperature (T_{g}) of the aliphatic polyamide and d) the temperature Tₘ−10° C., to cool and solidify the rotational molded article. After that, the rotational molded article is removed from the metal mold. The cooling time varies depending on the thickness of the rotational molded article, but the cooling time is generally within the range of a couple of minutes to several hours. During rotational molding, in order to prevent coloring and the deterioration of the rotational molded article, an inert gas atmosphere such as nitrogen gas is preferred because it is free or substantially free of oxygen inside the metal mold. The impact modified polyamide composition can alternatively be charged to the metal mold in a melted form; for example, by first charging the impact modified polyamide composition to an extruder, heating and meting the impact modified polyamide composition in the extruder, and then extruding the melted impact modified polyamide composition directly into a pre-heated metal mold.

Herein, the T_{g} of the aliphatic polyamide, mentioned above, is measured by the method according to ISO 11357-2:2020, with a heating ramp of 10° C./min. Herein, the Tₘ of the aliphatic polyamide, mentioned above, is measured by the method according to ISO 11357-3:2018, with a heating ramp of 10° C./min.

The molded article according to the present invention is a rotational molded article made from the impact modified polyamide composition according to the present invention, and/or any preferred embodiment thereof, as described herein above.

The rotational molded article according to the invention and obtained by the rotational molding process according to the present invention, can be, for example a container or a tank, and be used for different purposes, for example for pressurized gas containers, fuel tanks, and the like.

Due to its favorable properties, the impact modified polyamide composition according to the present invention may also be advantageously used in other molding processes, for example in an injection-molding process, or a blow molding process.

Accordingly, the present invention also includes a process comprising injection-molding or blow molding of the impact modified polyamide composition according to the present invention, or any preferred embodiment thereof, as described herein.

The present invention also includes a molded article being an injection molded article or a blow molded article made from the impact modified polyamide composition according to the present invention, and any preferred embodiment thereof, as described herein above.

In addition, or as alternative, the invention relates to the following variations.

In a variation 1) there is provided an impact modified polyamide composition comprising
X parts by weight (pbw) of an aliphatic polyamide (APA), and
Y parts by weight (pbw) of a modified polyolefin impact modifier (MIM), wherein
the aliphatic polyamide (APA) has a relative viscosity (RV), measured at 0.01 g/ml in 96% sulphuric acid and at 25° C. by the method according to ISO307:2019, of at most 2.40;
the modified polyolefin impact modifier (MIM) has a melt flow rate (MFR), measured at 230° C. and a test load of 2.16 kg by the method according to ISO 1133:2011, of at most 15 g/10 min; and
the sum of X and Y is 100 pbw, and wherein
X is at most 77.5 pbw and Y is at least 22.5 pbw, and
for the relative viscosity (RV) of the aliphatic polyamide (APA) up to and including 2.20, X is at least 60 pbw and Y is at most 40 pbw;
for the relative viscosity (RV) of the aliphatic polyamide (APA) in a range between above 2.20 and up to and including 2.33, X is at least 65 pbw and Y is at most 35 pbw; and
for the relative viscosity (RV) of the aliphatic polyamide (APA) in a range between above 2.33 and up to and including 2.40, X is at least 70 pbw and Y is at most 30 pbw.

In a second variation the impact modified polyamide composition is according to variation 1, wherein the aliphatic polyamide (APA) is an AB polymer or an AB/AABB polymer, preferably an AB polymer, more preferably a polyamide 6/66 copolymer or an AB polymer selected from polyamide 6 (PA-6), polyamide 11 (PA-11) and polyamide 12 (PA-12), and a copolymer or mixture thereof.

In third variation the impact modified polyamide composition is according to variation 1 or 2, wherein the aliphatic polyamide (APA) has a melting temperature (Tm), measured by the method according to ISO 11357-3:2018, with a heating ramp of 10° C./min, of at most 260° C.

In a fourth embodiment the impact modified polyamide composition isd according to any one of embodiments 1-3, wherein the relative viscosity (RV) of the aliphatic polyamide (APA) is in the range of 1.86-2.37, preferably in the range of 1.98-2.31.

In a fifth variation the impact modified polyamide composition according to any one of variation 1-4, wherein the melt flow rate (MFR) of the modified polyolefin impact modifier (MIM) is in a range of 0.5-10 g/10 min, preferably in the range of 0.8-5 g/10 min, more preferably in the range of 1.0-3 g/10 min.

In a sixth variation the impact modified polyamide composition according to any one of the above variations 1-5, wherein the modified polyolefin impact modifier (MIM) comprises a polyolefin copolymer backbone modified with acid functional groups.

In a seventh variation the impact modified polyamide composition according to any one of variation 1-6, wherein the modified polyolefin impact modifier (MIM), has
a glass transition temperature (Tg), measured by the method according to ISO 11357-2:2020, of at most −50° C., preferably at most −55° C.; and/or
a density, measured by the method according to ASTM D1505-03, of at most 0.95 g/cm3; preferably at most 0.90 g/cm3, and more preferably at most 0.85 g/cm3; and/or
a shore A hardness, measured by the method according to ASTM D2240-15, of at most 90, preferably at most 80, more preferably at most 75.

In an eight variation the impact modified polyamide composition according to any one of variation 1-7, wherein
for the relative viscosity (RV) of the aliphatic polyamide (APA) up to and including 2.20, X is in the range of 62.5-75 pbw and Y is in the range of 25-37.5 pbw;
for the relative viscosity (RV) of the aliphatic polyamide (APA) above 2.20 up to and including 2.27, X is in the range of 65-75 pbw and Y is in the range of 25-35 pbw;
for the relative viscosity (RV) of the aliphatic polyamide (APA) in the range of above 2.27 and up to and including 2.33, X is at least 69 and Y is at most 31 pbw;
the relative viscosity (RV) of the aliphatic polyamide (APA) in the range of above 2.33 and up to and including 2.40, X is at least 72.5 pbw and Y is at most 27.5 pbw.

In a ninth variation the impact modified polyamide composition according to any one of variation 1-8, having
a complex viscosity (Eta*) at 250° C. of at most 700 Pa·s;
an elongation at break at −40° C. of at least 17.5%;
a notched impact strength at 23° C. of at least 70 KJ/m2; and
a falling weight impact resistance at −40° C. with a success rate of at least 60%;
   wherein
the complex viscosity (Eta*) is measured with dynamic mechanical spectroscopy (DMS) by the method according to ISO 6721-10, with loading time t=5 min, at an angular frequency of 0.1 rad/s;
the elongation at break is measured by the method according to ISO 527-2:2012 Type 1A at a drawing rate 50 mm/min;
the notched impact strength is measured by the method according to ISO 179-2:2020; and
the falling weight impact resistance is measured is on injection molded plaques of 80*80*2 mm by the method according to ISO 6603-2-2000-10.

In a tenth variation the impact modified polyamide composition according to any of variation 1-9, wherein the composition comprises one or more other polymer components and/or one or more additives in a total amount in the range of 0.001-30 pbw, relative to the 100 pbw for the combined amount of X of the aliphatic polyamide (APA) and Y of the modified polyolefin impact modifier (MIM).

In an eleventh variation the impact modified polyamide composition according to any one of variation 1-10, comprising
a. an organic stabilizer in an amount of at least 0.5 pbw, relative to 100 pbw for the combined amount of X of the aliphatic polyamide (APA) and Y of the modified polyolefin impact modifier (MIM); and
b. a copper based inorganic stabilizer in an amount of at least 50 parts per million (ppm) of Cu, relative to the total weight of the composition.

In a twelfth variation there is provided a process for making an impact modified polyamide composition, comprising melt-mixing of
X parts by weight of an aliphatic polyamide (APA), and
Y parts by weight of a modified polyolefin impact modifier (MIM),
wherein the APA and the MIM, and X and Y are according to any one of variation 1-11.

In a thirteenth variation there is provided a process for making an impact modified article, comprising melt processing of a polyamide composition comprising
X parts by weight of an aliphatic polyamide (APA), and
Y parts by weight of a modified polyolefin impact modifier (MIM),
wherein the impact modified polyamide composition and the APA and the MIM, and X and Y are according to any one of variation 1-11.

In a fourteenth embodiment the process is according to variation 13, wherein the melt processing is done by rotational molding.

In a variation embodiment there is provided a rotational molded article made of an impact modified polyamide composition comprising
X parts by weight of an aliphatic polyamide (APA), and
Y parts by weight of a modified polyolefin impact modifier (IM),
wherein the polyamide composition and the APA and the MIM, and X and Y are according to any of the variation 1-11.

The invention is further illustrated with the following examples and comparative experiments.

### EXAMPLES AND COMPARATIVE EXPERIMENTS AND TEST RESULTS

### Materials

| | |
|---|---|
| Polyamide-1 | Polyamide 6 (PA6), Tₘ = 220° C., relative viscosity (RV) at 0.01 g/ml |
| | in 96% sulphuric acid and at 25° C. of 2.51 (ex DSM). |
| Polyamide-2 | Polyamide 6 (PA6), Tₘ = 220° C., relative viscosity (RV) at 0.01 g/ml |
| | in 96% sulphuric acid and at 25° C. of 2.09 (ex DSM). |
| Impact | Acid modified ethylene-butylene polyolefin: 0.5 wt. % maleic |
| modifier-1 | anhydride; MFR 0.9 g/10 min at 190° C., 2.16 kg; MFR 1.8 g/10 min |
| | at 230° C., 2.16 kg; T_{g} −65° C.; density 870 kg/m³, Shore A hardness |
| | 70 (ex Mitsui). |
| Impact | Acid modified ethylene-butylene polyolefin: 1 wt. % maleic |
| modifier-2 | anhydride; MFR 0.6 g/10 min at 190° C., 2.16 kg; MFR 1.2 g/10 min |
| | at 230° C., 2.16 kg; T_{g} −65° C.; density 866 kg/m³, Shore A hardness |
| | 55; (ex Mitsui). |
| Impact | Acid modified ethylene-butylene polyolefin, 1.0 wt. % maleic |
| modifier-3 | anhydride; MFR 3.6 g/10 min at 190° C., 2.16 kg; MFR 7.4 g/10 |
| | min at 230° C., 2.16 kg; T_{g} −48° C.; density 882 kg/m³ (ex DOW). |
| Impact | Ethylene 1-octene polyolefin; MFR 1.1 g/10 min at 190° C., 2.16 kg; |
| modifier-4 | T_{g} −50° C.; density 885 kg/m³ (ex Borealis). |
| Impact | Acid modified ethylene-butylene polyolefin: 0.5 wt. % maleic |
| modifier-5 | anhydride; MFR 40 g/10 min at 190° C., 2.16 kg; MFR 70 g/10 min |
| | at 230° C., 2.16 kg; density 872 kg/m³, Shore A hardness 72 (ex |
| | Mitsui). |
| Impact | Acid modified ethylene-butylene polyolefin: 0.75 wt. % maleic |
| modifier-6 | anhydride; MFR 11 g/10 min at 190° C., 2.16 kg; MFR 23 g/10 min |
| | at 230° C., 2.16 kg; T_{g} −65° C.; density 896 kg/m³, Shore A hardness |
| | 89; (ex Mitsui). |
| Lubricant | Calcium salt of long chain, saturated, linear carboxylic acids |
| | (montanic acids) (ex Clariant). |
| Talcum | Microtalcum (ex Mineral Group). |
| Stabilizer-1 | Irganox 1098 (N,N′-(hexane-1,6-diyl)bis[3-(3,5-di-tert-butyl-4- |
| | hydroxyphenyl)propanamide], primary antioxidant) (ex BASF) |
| Stabilizer-2 | Chimassorb 944 (poly[6-[(1,1,3,3-tetramethylbutyl)amino]-1,3,5- |
| | triazine-2,4-diyl][(2,2,6,6-tetramethyl-4-piperidinyl)imino]-1,6 |
| | hexanediyl[(2,2,6,6-tetramethyl-4-piperidinyl)imino]]): an oligomeric |
| | hindered amine light stabilizer (HALS) and heat stabilizer) (ex |
| | BASF). |
| Stabilizer-3 | CuI/KBr (3 wt. % copper) (ex PolyAdd Services). |
| Aromatic PA | Zytel HTN301, Tm = 230-280° C., density 1190 kg/m3 (ex DuPont). |
| Glass fiber | E6CR10-4,5-568H, filament diameter 9-11 micrometre, chop |
| | length 3.50-5.50 micrometre (ex Jushi). |
| Black | N54-1033, 40% solvent black 7 (nigrosine) in PA6, density 1.19 |
| colorant | g/cm³ (ex Colloids). |

### Processing

### Compounding

The molding compositions were produced in a ZSK25 twin-screw extruder with a flat temperature profile from 250 to 260° C. and with pelletization. The components (see Table 1) were premixed and dosed at the throat. Unless specified otherwise, all compositions were prepared with an additive package consisting of 8.5 wt. % of a lubricant, 1.5 wt. % of talcum, 20 wt. % of Irganox 1098, 10 wt. % of Chimassorb 944, and 10 wt. % of CuI/KBr, the weight percentages (wt. %) based on the total weight of the additive package, all premixed in a masterbatch having 50 wt % of polyamide-1.

Comparative examples and compositions according to the invention listed under Tables 5-6 were prepared as specified above with additional of micro talcum and IM-4 to contents as specified in Tables 5-6.

### Molding

Prior to molding, all materials were dried for 16 h at 120° C. inside a vacuum oven with a N₂ purge. For the preparation of the test samples, injection molding was done on a Fanuc-2 injection machine, type α-S50iA, provided with an appropriate mold cavity, and applying a barrel temperature of 260° C. and a mold cavity temperature of 90° C.

### Test Methods

### Relative Viscosity

The relative viscosity of the polyamide polymers, respectively of the mixture thereof, was measured in sulphuric acid at a concentration of 1 g in 100 g m-cresol at a temperature of 25° C. by the method according to ISO 307.

### Flow Resistance

The flow resistance was measured as a dynamic viscosity with dynamic mechanical spectroscopy (DMS) by the method according to ISO 6721-10, with loading time t=5 min, angular frequency 100-0.1 rad/s and 3 measuring points per decade. From these measurements, the complex viscosity (Eta*) at 0.1 rad/s is reported.

### Tensile Properties DAM

The elongation at break was measured in a tensile test at −40° C., with a drawing rate of 50 mm/min, on Type 1A test samples, by the method according to ISO 527-2:2012.

### Notched Impact Resistance

The notched impact strength was measured at 23° C. by the method according to ISO 179-2:2020.

### Falling Weight Impact Resistance

The falling weight impact resistance was measured at −40° C. on injection molded plaques of 80*80*2 mm by the method according to ISO 6603-2-2000-10. The number of brittle failures out of 5 tests was reported.

### Compositions and Test Results

The compositions according to the present invention (Examples, EX) and the Comparative Experiments (CE), and test results obtained with these Examples and Comparative Experiments are reported in Tables 1, 2, 3, 4, 5, and 6. The wt % are based on the total weight of the weight of the impact modified polyamide composition.

TABLE 1
Compositions and test results for Comparative Experiments 1-9.

| | Components (wt. %) | | | | | | | | |
|---|---|---|---|---|---|---|---|---|---|
| Experiments | CE-1 | CE-2 | CE-3 | CE-4 | CE-5 | CE-6 | CE-7 | CE-8 | CE-9 |
| Polyamide-1 | 96.4 | 76.4 | | 76.4 | 38.2 | | 38.2 | 33.2 | |
| Polyamide-2 | | | 76.4 | | 38.2 | 76.4 | 38.2 | 33.2 | 66.4 |
| Impact modifier 3 | | | | 6 | 6 | 6 | 10 | 15 | 15 |
| Impact modifier 4 | | | | 14 | 14 | 14 | 10 | 15 | 15 |
| Impact modifier 5 | | 20 | 20 | | | | | | |
| Additive package | 3.6 | 3.6 | 3.6 | 3.6 | 3.6 | 3.6 | 3.6 | 3.6 | 3.6 |
| Parameters | | | | | | | | | |
| RV-PA | 2.51 | 2.51 | 2.09 | 2.51 | 2.30 | 2.09 | 2.30 | 2.30 | 2.09 |
| X (pbw, r.t. X + Y) | 100 | 79.3 | 79.3 | 92.7 | 92.7 | 92.7 | 88.4 | 81.6 | 81.6 |
| Y (pbw, r.t. X + Y) | 0 | 20.7 | 20.7 | 7.3 | 7.3 | 7.3 | 11.6 | 18.4 | 18.4 |
| Test results | | | | | | | | | |
| Eta* [Pa · s] | 220 | 926 | 154 | 740 | 363 | 152 | 347 | 1107 | 344 |
| Rating ^{a)} | ∘∘ | x | ∘∘ | x | ∘∘ | ∘∘ | ∘∘ | xx | ∘∘ |
| EaB −40° C. [%] | 9.7 | 17.5 | 20.5 | 18.3 | | 18.7 | | | 27 |
| Rating ^{b)} | x | ∘ | ∘∘ | ∘ | | ∘ | | | ∘∘ |
| Impact [KJ/m²] | 2.82 | 32.9 | 15.2 | 47.2 | 48.6 | 14.8 | 48.0 | 55.4 | 83.7 |
| Rating ^{c)} | x | x | x | x | x | x | x | x | ∘∘ |
| Falling weight (#) | 5 | 3 | 4 | 4 | | 3 | | | 5 |
| Rating ^{d)} | x | x | x | x | | x | | | x |

^{a)} Above 700 Pa · s: x = bad; 500-700 Pa · s: ∘ = acceptable; below 500 Pa · s: ∘∘ = good;
^{b)} Below 17.5%: x = bad; 17.5-20%: ∘ = acceptable; above 20%: ∘∘ = good;
^{c)} Below 60 KJ/m³: x = bad; 60-80 KJ/m³: ∘ = acceptable; above 80 KJ/m³: ∘∘ = good;
^{d)} 3-5 failures out of 5: x = bad; 2 failures out of 5: ∘ = acceptable; 0-1 failures out of 5: ∘∘ = good.

The results in Table 1 show that the mechanical properties of a polyamide without impact modifier (CE-1) can be improved by addition of an impact modifier, however at the cost of an increased flow resistance (see CE-2; comprising an acid modified polyolefin impact modifier; CE-4 comprising a combination of an acid modified polyolefin impact modifier and a non-modified polyolefin). The flow can be improved by using a polyamide with a lower viscosity; however, the mechanical properties hardly increase, or even go down, in particular the impact resistance drops drastically upon further lowering the relative viscosity of the polyamide (see CE-3; comprising an acid modified polyolefin impact modifier; and CE-4 and CE-5 comprising the same combination of acid modified polyolefin impact modifier and non-modified polyolefin). Furthermore, the difference between the compositions CE-2 and CE-3 on one hand (comprising the single acid modified polyolefin impact modifier) and CE-4 and CE-6 on the other hand (comprising the same combination of acid modified polyolefin impact modifier and non-modified polyolefin) are limited, one performing slightly better in one property, less in another property. Moreover, all these comparative experiments failed in the impact test with the falling weight.

By further increasing the amount of acid modified polyolefin impact modifier in combination with the non-modified polyolefin, the impact resistance becomes better, but in an insufficient degree, and at the cost of a drastic reduction in flowability. This is illustrated with CE-8 in comparison with CE-7 and CE-5. When the polyamide of CE-8 is substituted with the polyamide with the lower viscosity, not only the flowability is improved, but also the impact resistance, which highly surprisingly, contrary to general observations, and contrary to the result observed above for CE-3 compared to CE-2, whereas the values for the elongation at break are also acceptable to good. However, also this composition fails in the impact test with the falling weight.

Table 2 shows the compositions and results for Comparative Experiments 10-12 and Examples A-D with a modified polyolefin impact modifier according to the present invention. The compositions of Comparative Experiments CE-10-12 comprise the modified polyolefin impact modifier in an amount of 20 wt. % based on the total weight of the composition. Although the impact resistance for CE-10 is at an acceptable level, the flow resistance is too high. The flow resistance can be lowered by using a polyamide with a lower relative viscosity (RV), as is illustrated by CE-11 and CE-12; however, the impact resistance decreases drastically, in particular when lowering further from a relative viscosity (RV) of 2.31 in CE-11 to 2.09 in CE-12. Meanwhile, also these compositions fail in the impact test with the falling weight, as shown for CE-11.

TABLE 2
Compositions and test results for Comparative
Experiments 10-12 and Examples A-D.

| | Components (wt. %) | | | | | | |
|---|---|---|---|---|---|---|---|
| Experiments | CE-10 | CE-11 | CE-12 | EX-A | EX-B | EX-C | EX-D |
| Polyamide-1 | 76.4 | 38.2 | | 35.7 | 33.2 | | |
| Polyamide-2 | | 38.2 | 76.4 | 35.7 | 33.2 | 66.4 | 61.4 |
| Impact modifier 1 | 20 | 20 | 20 | 25 | 30 | 30 | 35 |
| Additive package | 3.6 | 3.6 | 3.6 | 3.6 | 3.6 | 3.6 | 3.6 |
| Parameters | | | | | | | |
| RV-PA | 2.51 | 2.30 | 2.09 | 2.30 | 2.30 | 2.09 | 2.09 |
| X (pbw, r.t. X + Y) | 79.3 | 79.3 | 79.3 | 74.1 | 68.9 | 68.9 | 63.8 |
| Y (pbw, r.t. X + Y) | 20.7 | 20.7 | 20.7 | 25.9 | 31.1 | 31.1 | 36.2 |
| Test results | | | | | | | |
| Eta* [Pa · s] | 724 | 326 | 148 | 452 | 674 | 296 | 456 |
| Rating ^{a)} | x | ∘∘ | ∘∘ | ∘∘ | ∘ | ∘∘ | ∘∘ |
| EaB −40° C. [%] | | 22 | | 24 | 40 | 40 | 43 |
| Rating ^{b)} | | ∘∘ | | ∘∘ | ∘∘ | ∘∘ | ∘∘ |
| Impact [KJ/m²] | 75.5 | 56.15 | 20.9 | 86.7 | 96.0 | 93.0 | 95.9 |
| Rating ^{c)} | ∘ | x | x | ∘∘ | ∘∘ | ∘∘ | ∘∘ |
| Falling weight (#) | | 4 | | 2 | 0 | 0 | 0 |
| Rating ^{d)} | | x | | ∘ | ∘∘ | ∘∘ | ∘∘ |

Ratings for ^{a)}, ^{b)}, ^{c)}, and ^{d)} same as above in Table 1.

Contrary to the above results for CE-10-12, the compositions of Examples A-D according to the present invention show good or improved results for all properties, including good values for falling weight resistance. More particular, Example A comprises a higher amount of modified polyolefin impact modifier, compared to CE-11, which results not only in an improvement in impact resistance, and good values for the elongation at break, but also in retention of the flowability and, surprisingly, in an acceptable result for the falling weight impact test.

The differences in effects with the impact modifier combination used in the comparative experiments is clearly demonstrated with the comparison between CE-7 and CE-8 on one hand, and CE-11, EX-A and EX-B on the other hand, all based on the same mixture of polyamide. CE-7 comprises 20 wt. % of the impact modifier combination and has a Charpy impact resistance of 48.0 kJ/M². In CE-8 the amount of the impact modifier combination is increased to 30 wt. %, which results in a moderate increase in Charpy impact resistance to 55.4 kJ/m². CE-11 comprises 20 wt. % of the modified polyolefin impact modifier complying with the invention, showing a Charpy impact resistance of 56.15 kJ/m². In Example A (EX-A), the amount of the modified polyolefin impact modifier is increased to 25 wt. %, which results in a significant increase in Charpy impact resistance to 86.7 kJ/m². In Example B (EX-B), the amount of the modified polyolefin impact modifier is further increased to 30 wt. %, which results in a further increase in Charpy impact resistance to 96.0 kJ/m². Further increasing the amount of modified polyolefin impact modifier, as in Example B, results in a further improvement in impact resistance, as well as in elongation at break, but also in retention of the flowability at an acceptable level, and in a good result for the falling weight impact test. Lowering the relative viscosity (RV) for the composition with 30 wt. % of modified polyolefin impact modifier, as is done in Example C (EX-C), in comparison with Example B, not only improves the flow resistance, but also even further improves the elongation at break, with retention of the impact resistance at a high level, which is in contrast with the opposite results for CE-11 and CE12, and in in a good result for the falling weight impact test, which is in clear contrast with the result for CE-9, mentioned above. As shown by Example D (EX-D), the amount of impact modifier can be even further increased, with retention of very good mechanical properties while flowability is still at an acceptable level.

Table 3 shows the compositions and test results for Examples E-F and Comparative Experiments 13-14, wherein the only difference is in the modified impact modifier. Examples E-F comprise a modified impact modifier according to the present invention, different from the one used in Examples A-D, but both having a melt flow rate (MFR), measured at 230° C. and a test load of 2.16 kg by the method according to ISO 1133:2011, of at most 15 g/10 min. As the results show, both Example E (EX-E) and Example F (EX-F) show good mechanical properties, including a good falling weight resistance at low temperature, in combination with a good flowability.

TABLE 3
Compositions and test results for Examples
E-F and Comparative Experiments 13-14

Experiments

| | EX-E | EX-F | CE-13 | CE-14 |
|---|---|---|---|---|
| Components (wt. %) | | | | |
| Polyamide-1 | | | | |
| Polyamide-2 | 66.4 | 66.4 | 66.4 | 66.4 |
| Impact modifier 2 | 30 | | | |
| Impact modifier 3 | | 30 | | |
| Impact modifier 5 | | | 30 | |
| Impact modifier 6 | | | | 30 |
| Additive package | 3.6 | 3.6 | 3.6 | 3.6 |
| Parameters | | | | |
| RV-PA | 2.09 | 2.09 | 2.09 | 2.09 |
| X (pbw, r.t. X + Y) | 68.9 | 68.9 | 68.9 | 68.9 |
| Y (pbw, r.t. X + Y) | 31.1 | 31.1 | 31.1 | 31.1 |
| Test results | | | | |
| Eta* [Pa · s] | 334 | 412 | 352 | 422 |
| Rating ^{a)} | ∘∘ | ∘∘ | ∘∘ | ∘∘ |
| EaB −40° C. [%] | 48 | 25 | 24 | 17.4 |
| Rating ^{b)} | ∘∘ | ∘∘ | ∘∘ | x |
| Impact [KJ/m²] | 86.6 | 76.5 | 61.5 | 41.1 |
| Rating ^{c)} | ∘∘ | ∘ | ∘ | x |
| Falling weight (#) | 0 | 0 | 4 | 4 |
| Rating ^{d)} | ∘∘ | ∘∘ | x | x |

Ratings for ^{a)}, ^{b)} ^{c)} and ^{d)} same as above in Table 1.

Comparative Experiments 13-14 (CE-13 and CE14) comprise different modified impact modifier, both not according to the present invention, whilst having a melt flow rate (MFR), measured at 230° C. and a test load of 2.16 kg by the method according to ISO 1133:2011, of at most 15 g/10 min. As the results show, both Comparative Experiments show good flowability but fail in mechanical properties, in particular in the falling weight resistance at low temperature.

Table 4 shows various examples (Examples G-M) with different compositions according to the present inventions. Examples G-K show that the additive package can be varied widely without hardly affecting the mechanical properties while retaining a good flowability. Examples L-N show that polymers, other than the modified polyolefin impact modifier, can be added while retaining good mechanical properties in combination with an acceptable flowability, provided that the amount (Y) of modified polyolefin impact modifier in the composition is at least 22.5 pbw, relative to 100 pbw for the combined amount (Y) of modified polyolefin impact modifier (MIM) and the amount (X) of aliphatic polyamide (APA). This in contrast with compositions wherein the amount of modified impact modifier is below the minimum amount according to the present invention, even when the total amount of impact modifier is kept constant. In this respect, comparison of Example M (EX-M) and for Comparative Experiments 8 and 9 (CE-8 and CE-9) show relevant results. All three compositions have the same total amount of impact modifier (30 wt. %), however, CE-8 and CE-9 (compositions and results shown in Table 1) comprise less modified polyolefin impact modifier (MIM) and more non-modified polyolefin impact modifier, compared to EX-M. The composition according to the invention EX-M shows an acceptable flowability and good mechanical properties, whereas Comparative Experiments CE-8 and CE-9 fail at least on either flowability or on the falling weight resistance at low temperature.

TABLE 4
Compositions and test results for Examples G-N.

| | Components (wt. %) | | | | | | | |
|---|---|---|---|---|---|---|---|---|
| Experiments | EX-G | EX-H | EX-I | EX-J | EX-K | EX-L | EX-M | EX-N |
| Polyamide-1 | | | | | 36.45 | 34.5 | 33.2 | 33.2 |
| Polyamide-2 | 68.3 | 67.85 | 69.7 | 66.9 | 36.45 | 34.5 | 33.2 | 33.2 |
| Impact modifier 1 | 30 | 30 | 30 | 30 | 25 | 25 | 25 | 25 |
| Impact modifier 4 | | | | | | 2.4 | 5 | |
| Amorphous PPA | | | | | | | | 5 |
| Stabilizer Package | | | | | | 3.6 | 3.6 | 3.6 |
| Lubricant | 0.3 | 0.3 | 0.3 | 0.3 | 0.3 | | | |
| Talcum | | 1.85 | | | | | | |
| Black colorant | | | | 1 | | | | |
| Stabilizer | 1.4 | | | 1.8 | 1.8 | | | |
| Parameters | | | | | | | | |
| RV-PA | 2.09 | 2.09 | 2.09 | 2.09 | 2.30 | 2.30 | 2.30 | 2.30 |
| X (pbw, r.t. X + Y) | 69.5 | 69.3 | 69.9 | 69.0 | 74.5 | 73.5 | 72.8 | 72.8 |
| Y (pbw, r.t. X + Y) | 30.5 | 30.7 | 30.1 | 31.0 | 25.5 | 26.5 | 27.2 | 27.2 |
| Test results | | | | | | | | |
| Eta* [Pa · s] | 273 | 288 | 251 | 270 | 437 | 512 | 683 | 556 |
| Rating ^{a)} | ∘∘ | ∘∘ | ∘∘ | ∘∘ | ∘∘ | ∘ | ∘ | ∘ |
| EaB −40° C. [%] | 29 | 36 | 25 | 25 | 22 | 26 | 29 | 23 |
| Rating ^{b)} | ∘∘ | ∘∘ | ∘∘ | ∘∘ | ∘∘ | ∘∘ | ∘∘ | ∘∘ |
| Impact [KJ/m²] | 96.6 | 88.4 | 92.6 | 84.5 | 82.9 | 90.7 | 94 | 87.5 |
| Rating ^{c)} | ∘∘ | ∘∘ | ∘∘ | ∘∘ | ∘∘ | ∘∘ | ∘∘ | ∘∘ |
| Falling weight (#) | 0 | 0 | 0 | 0 | 0 | 0 | 0 | 1 |
| Rating ^{d)} | ∘∘ | ∘∘ | ∘∘ | ∘∘ | ∘∘ | ∘∘ | ∘∘ | ∘∘ |

Ratings for ^{a)}, ^{b)}, ^{c)} and ^{d)} same as above in Table 1.

Table 5 shows examples (Examples O-P) with different compositions according to the present inventions. Examples O-P show that compositions with a micro talcum content 0.5 and 1.85 wt % (with respect to total mass of the composition) realize beneficial properties. From comparative examples 15-19 it follows that incorporation of an excess of other constituents Z, specifically exemplified for compositions having more than 30 pbw glass fiber (CE-15), more than 30 pbw of an aromatic polyamide (CE-16), more than 30 pbw of an aromatic PA+GF (CE-17), respectively more than 2 pbw of micro talcum (CE-18 and CE-19), negatively affects one or more of: flow properties, tensile properties, notched impact resistance, and falling weight resistance.

Note that for samples according to the invention, i.e. having their respective constituents within the claimed ranges and no-excess of others (components Z) such negative effects were not observed. In terms of impact resistance, the results confirm good performance for samples having up to 1 pbw of micro talcum, acceptable impact rating for samples with up to 2 pbw micro talcum, and comparatively reduced performance for samples with a higher micro talcum content.

TABLE 5
Compositions and test results for and Examples
O-P and Comparative Experiments 15-19

| | Components (wt. %) | | | | | | |
|---|---|---|---|---|---|---|---|
| Experiments | EX-O | EX-P | CE-15 | CE-16 | CE-17 | CE-18 | CE-19 |
| Polyamide-2 | 66.45 | 67.8 | 33.25 | 33.25 | 28.25 | 55.80 | 65.80 |
| Impact modifier 1 | 30 | 30 | 30 | 30 | 30 | 30 | 30 |
| Amorphous PPA | | | | 35 | 20 | | |
| Glass Fiber | | | 35 | | 20 | | |
| Micro talcum | 1.85 | 0.5 | 0.05 | 0.05 | 0.05 | 12.5 | 2.5 |
| Lubricant | 0.3 | 0.3 | 0.3 | 0.3 | 0.3 | 0.3 | 0.3 |
| Stabilizer package | 1.4 | 1.4 | 1.4 | 1.4 | 1.4 | 1.4 | 1.4 |
| Parameters | | | | | | | |
| RV-PA | 2.09 | 2.09 | 2.09 | 2.09 | 2.09 | 2.09 | 2.09 |
| X (pbw, r.t. X + Y) | 67.9 | 69.9 | 52.6 | 52.6 | 48.5 | 65.7 | 69.3 |
| Y (pbw, r.t. X + Y) | 32.1 | 30.1 | 47.4 | 47.4 | 51.5 | 34.3 | 30.7 |
| Test results | | | | | | | |
| Eta* [Pa · s] | 259 | 248 | 35507 | 5567 | 92347 | 655 | 291 |
| Rating ^{a)} | ∘∘ | ∘∘ | x | x | x | ∘ | ∘∘ |
| EaB −40° C. [%] | 48.7 | 56.7 | 6.6 | 93.1 | 6.6 | 58.2 | 43.5 |
| Rating ^{b)} | ∘∘ | ∘∘ | x | ∘∘ | x | ∘∘ | ∘∘ |
| Impact [KJ/m²] | 75.2 | 85.7 | 54.1 | 121.7 | 39.7 | 21.9 | 70.6 |
| Rating ^{c)} | ∘ | ∘∘ | x | ∘∘ | x | x | ∘ |
| Falling weight (#) | 0 | 0^{e)} | 5 | 1 | 5 | 5 | 5 |
| Rating ^{d)} | ∘∘ | ∘∘ | x | ∘∘ | x | x | x |

Ratings for ^{a)}, ^{b)} ^{c)} and ^{d)} same as above in Table 1.
^{e)}0 failures out of 4 tests.

Table 6 displays results for examples (EX-Q, EX-R) with different compositions according to the present inventions as well as comparative examples CE-20 and CE-21. It follows that addition of more than 10 pbw of an unmodified IM (IM-4) negatively affects rotamoldability, especially in terms of displaying a comparatively poor flowability, which is believed to be occasioned by a phase inversion to a system having a discontinuous polyamide phase in an olefin matrix. In contrast examples L, M, Q and R, having no excess of unmodified impact modifier, display good performance in flowability, tensile properties, and falling weight resistance, in combination with an at least acceptable performance in terms of impact resistance. Differences in performances in flow properties and impact rating between EX-R and EX-Q are believed to related to differences in maleic anhydride content.

TABLE 6
Compositions and test results for and Examples
Q-R and Comparative Experiments 20-21

Experiments

| | EX-Q | EX-R | CE-20 | CE-21 |
|---|---|---|---|---|
| Components (wt. %) | | | | |
| Polyamide-1 | 37.75 | 37.75 | 29.15 | 26.65 |
| Polyamide-2 | 35.5 | 35.5 | 29.1 | 26.6 |
| Impact modifier 1 | 25 | | 25 | 25 |
| Impact modifier 2 | | 25 | | |
| Impact modifier 4 | | | 15 | 20 |
| Micro talcum | 0.05 | 0.05 | 0.05 | 0.05 |
| Lubricant | 0.3 | 0.3 | 0.3 | 0.3 |
| Stabilizer package | 1.4 | 1.4 | 1.4 | 1.4 |
| Parameters | | | | |
| RV-PA | 2.37 | 2.37 | 2.30 | 2.30 |
| X (pbw, r.t. X + Y) | 74.5 | 74.5 | 70.0 | 68.0 |
| Y (pbw, r.t. X + Y) | 25.5 | 25.5 | 30.0 | 32.0 |
| Test results | | | | |
| Eta* [Pa · s] | 439 | 570 | 2598 | 3651 |
| Rating ^{a)} | ∘∘ | ∘ | x | x |
| EaB −40° C. [%] | 35.4 | 46.3 | 150.7 | 145.2 |
| Rating ^{b)} | ∘∘ | ∘∘ | ∘∘ | ∘∘ |
| Impact [KJ/m²] | 83.8 | 99.3 | 103.6 | 102.3 |
| Rating ^{c)} | ∘∘ | ∘∘ | ∘∘ | ∘∘ |
| Falling weight (#) | 1 | 0 | 0 | 0 |
| Rating ^{d)} | ∘∘ | ∘∘ | ∘∘ | ∘∘ |

Ratings for ^{a)}, ^{b)} ^{c)} and ^{d)} same as above in Table 1.

1. An impact modified polyamide composition consisting of:
X parts by weight (pbw) of an aliphatic polyamide (APA), and
Y parts by weight (pbw) of a modified polyolefin impact modifier (MIM), and
0-30 parts by weight (pbw), relative to 100 pbw of X and Y combined, of one or more other polymer components and/or one or more additives together referred to as other components Z;
wherein
the aliphatic polyamide (APA) has a relative viscosity (RV), measured at 0.01 g/ml in 96% sulphuric acid and at 25° C. by the method according to ISO307:2019, of at most 2.40;
the modified polyolefin impact modifier (MIM) has a melt flow rate (MFR), measured at 230° C. and a test load of 2.16 kg by the method according to ISO 1133:2011, of at most 15 g/10 min; and
the sum of X and Y is 100 pbw, and wherein
X is at most 77.5 pbw and Y is at least 22.5 pbw, and
for the relative viscosity (RV) of the aliphatic polyamide (APA) up to and including 2.20, X is at least 60 pbw and Y is at most 40 pbw;
for the relative viscosity (RV) of the aliphatic polyamide (APA) in a range between above 2.20 and up to and including 2.33, X is at least 65 pbw and Y is at most 35 pbw; and
for the relative viscosity (RV) of the aliphatic polyamide (APA) in a range between above 2.33 and up to and including 2.40, X is at least 70 pbw and Y is at most 30 pbw;
and wherein the other components Z comprise: 0-10 pbw of a non-modified polyolefin, and 0-2 pbw of a micro talcum, relative to the 100 pbw of the combined amount of X and Y.

2. The impact modified polyamide composition according to claim 1, wherein the aliphatic polyamide (APA) is an AB polymer or an AB/AABB polymer, preferably an AB polymer, more preferably a polyamide 6/66 copolymer or an AB polymer selected from polyamide 6 (PA-6), polyamide 11 (PA-11) and polyamide 12 (PA-12), and a copolymer or mixture thereof.

3. The impact modified polyamide composition according to claim 1, wherein the aliphatic polyamide (APA) has a melting temperature (Tm), measured by the method according to ISO 11357-3:2018, with a heating ramp of 10° C./min, of at most 260° C.

4. The impact modified polyamide composition according to claim 1, wherein the relative viscosity (RV) of the aliphatic polyamide (APA) is in the range of 1.86-2.37, preferably in the range of 1.98-2.31.

5. The impact modified polyamide composition according to claim 1, wherein the melt flow rate (MFR) of the modified polyolefin impact modifier (MIM) is in a range of 0.5-10 g/10 min, preferably in the range of 0.8-5 g/10 min, more preferably in the range of 1.0-3 g/10 min.

6. The impact modified polyamide composition according to claim 1, wherein the modified polyolefin impact modifier (MIM) comprises a polyolefin copolymer backbone modified with acid functional groups.

7. The impact modified polyamide composition according to claim 1, wherein the modified polyolefin impact modifier (MIM), has
a glass transition temperature (Tg), measured by the method according to ISO 11357-2:2020, of at most −50° C., preferably at most −55° C.; and/or
a density, measured by the method according to ASTM D1505-03, of at most 0.95 g/cm3; preferably at most 0.90 g/cm3, and more preferably at most 0.85 g/cm3; and/or
a shore A hardness, measured by the method according to ASTM D2240-15, of at most 90, preferably at most 80, more preferably at most 75.

8. The impact modified polyamide composition according to claim 1, wherein
for the relative viscosity (RV) of the aliphatic polyamide (APA) up to and including 2.20, X is in the range of 62.5-75 pbw and Y is in the range of 25-37.5 pbw;
for the relative viscosity (RV) of the aliphatic polyamide (APA) above 2.20 up to and including 2.27, X is in the range of 65-75 pbw and Y is in the range of 25-35 pbw;
for the relative viscosity (RV) of the aliphatic polyamide (APA) in the range of above 2.27 and up to and including 2.33, X is at least 69 and Y is at most 31 pbw;
for the relative viscosity (RV) of the aliphatic polyamide (APA) in the range of above 2.33 and up to and including 2.40, X is at least 72.5 pbw and Y is at most 27.5 pbw.

9. The impact modified polyamide composition according to claim 1, having
a complex viscosity (Eta*) at 250° C. of at most 700 Pa s;
an elongation at break at −40° C. of at least 17.5%;
a notched impact strength at 23° C. of at least 70 KJ/m2; and
a falling weight impact resistance at −40° C. with a success rate of at least 60%;
wherein
the complex viscosity (Eta*) is measured with dynamic mechanical spectroscopy (DMS) by the method according to ISO 6721-10, with loading time t=5 min, at an angular frequency of 0.1 rad/s;
the elongation at break is measured by the method according to ISO 527-2:2012 Type 1A at a drawing rate 50 mm/min;
the notched impact strength is measured by the method according to ISO 179-2:2020; and
the falling weight impact resistance is measured is on injection molded plaques of 80*80*2 mm by the method according to ISO 6603-2-2000-10.

10. The impact modified polyamide composition according to claim 1, wherein the composition comprises 0.001-1 pbw of micro talcum, relative to the 100 pbw of the combined amount of X and Y.

11. The impact modified polyamide composition according to claim 1, comprising:
a. an organic stabilizer in an amount of at least 0.5 pbw, relative to 100 pbw for the combined amount of X of the aliphatic polyamide (APA) and Y of the modified polyolefin impact modifier (MIM); and
b. a copper based inorganic stabilizer in an amount of at least 50 parts per million (ppm) of Cu, relative to the total weight of the composition.

12. A process for making an impact modified polyamide composition, comprising melt-mixing of
X parts by weight of an aliphatic polyamide (APA),
Y parts by weight of a modified polyolefin impact modifier (MIM), and
0-30 parts by weight (pbw), relative to 100 pbw of X and Y combined, of one or more other polymer components and/or one or more additives together referred to as other components Z;
wherein the APA and the MIM, and X, Y, and Z are according to claim 1.

13. A process for making an impact modified article, comprising melt processing of a polyamide composition consisting of
X parts by weight of an aliphatic polyamide (APA),
Y parts by weight of a modified polyolefin impact modifier (MIM), and
0-30 parts by weight (pbw), relative to 100 pbw of X and Y combined, of one or more other polymer components and/or one or more additives together referred to as other components Z;
wherein the impact modified polyamide composition and the APA and the MIM, and X, Y and Z are according to claim 1.

14. The process according to claim 13, wherein the melt processing is done by rotational molding.

15. Rotational molded article made of an impact modified polyamide composition comprising:
X parts by weight of an aliphatic polyamide (APA),
Y parts by weight of a modified polyolefin impact modifier (IM), and
0-30 parts by weight (pbw), relative to 100 pbw of X and Y combined, of one or more other polymer components and/or one or more additives together referred to as other components Z;
wherein the polyamide composition and the APA and the MIM, and X, Y, and Z are according to claim 1.
